(19) United States
(12) Patent Application Publication
(10) Pub. No.: US 2025/0263976 A1
(43) Pub. Date: Aug. 21, 2025

(54) HORIZONTAL ROLL SHADE SYSTEM WITH VARIABLE OPACITY

(71) Applicant: Edwin Torres, Cape Coral, FL (US)

(72) Inventor: Edwin Torres, Cape Coral, FL (US)

(21) Appl. No.: 19/198,841

(22) Filed: May 5, 2025

Related U.S. Application Data
(63) Continuation-in-part of application No. 17/949,312, filed on Sep. 21, 2022.
Application No. 17/949,312 is a continuation-in-part of application No. 16/854,958, filed on Apr. 22, 2020, now abandoned.
(60) Provisional application No. 63/648,208, filed on May 16, 2024.
(60) Provisional application No. 62/921,657, filed on Jul. 1, 2019.

(51) Int. Cl. E06B 9/42; E06B 9/24; E06B 9/58; E06B 9/70

(52) U.S. Cl. CPC E06B 9/42; E06B 9/58; E06B 9/70; E06B 2009/2405; E06B 2009/2458

(57) ABSTRACT

The present disclosure provides a window covering system comprising a head rail, a roller tube attached to one end of a horizontal roll shade, a fixed tube or holder attached to the other end of the horizontal roll shade, and a moveable tube positioned between the roller tube and the fixed tube or holder. The roll shade forms a loop between its ends. The system includes a mechanism coupled to the roller tube to selectively rotate the roller tube and thereby move the roll shade between a deployed position and a retracted position. A device is provided to move the moveable tube along the head rail. The system allows for horizontal deployment and retraction of the roll shade while maintaining proper tension and alignment.

### CROSS REFERENCE TO RELATED APPLICATIONS

This application further claims the benefit of U.S. Provisional Patent Application No. 63/648,208, filed on May 16, 2024. This application is also a continuation in part of U.S. patent application Ser. No. 17/949,312, filed on Sep. 21, 2022, is a continuation in part of U.S. patent application Ser. No. 16/854,958, filed on Apr. 22, 2020 and which claims priority to U.S. Provisional Patent Application No. 62/921,657, filed on Jul. 1, 2019., which are all incorporated by reference herein in their entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### FIELD OF INVENTION

The present disclosure relates to window covering systems, and more particularly to a horizontal roll shade system with variable opacity that can be deployed and retracted along a head rail.

### BACKGROUND

Window coverings are a common feature in residential and commercial buildings, providing privacy, controlling the amount of light entering a room, and contributing to the aesthetic appeal of the interior design. They come in various forms, including curtains, blinds, and shades, each with their own set of characteristics and mechanisms for operation.

Roll-up shades are a type of window covering that utilize a flexible fabric or other material suspended from a roller tube. The roller tube is typically enclosed in a head rail that is mounted above the window or door to be covered. By rotating the roller tube, the shade can be raised or lowered, thereby controlling the amount of light passing through the window.

In some instances, it may be desirable to alter not just the position of the window covering, but also the amount of light per unit area passing through it, i.e., to alter the opacity of the window covering. Devices such as horizontal mini blinds have been introduced to address this. These blinds consist of louvered slats that can be moved between raised and lowered positions and can also be rotated in concert with each other between open and closed configurations. Rotating the slats alters the amount of light passing through the blind.

Another type of window covering that allows for opacity control is the roll-up shade device, which features horizontal strips of fabric suspended between two sheets of fabric. The strips can be rotated to alter the opacity of the shade, but typically, this can be done when the shade is in the fully lowered position.

In the industry, there are also pleated shades and vertical blinds formed from multiple strips for shading a door or window in a horizontal manner. However, these types of window coverings do not address the deployment of a shade from one side.

Window coverings play a substantial role in the comfort and aesthetics of a space, and the mechanisms by which they operate can greatly influence their functionality and ease of use.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a window covering system is provided. The window covering system includes a head rail mounted above a window or door, a roller tube attached to one end of a horizontal roll shade, a fixed tube or holder attached to the other end of the horizontal roll shade, and a moveable tube positioned between the roller tube and the fixed tube or holder. The roll shade forms a loop between its ends. The system also includes a mechanism coupled to the roller tube to selectively rotate the roller tube and thereby move the roll shade between a deployed position, wherein the roll shade is open, and a retracted position, wherein the roll shade is closed. The moveable tube is driven by a device to move it along said head rail and said device is selected from the group consisting of manually, motorized using a belt, cable, string, rack and pinion, chain or pneumatic or hydraulic cylinder.

According to other aspects of the present disclosure, the window covering system may include one or more of the following features. The system may include a roll shade guide or fabric clamp on the head rail, wherein the roll shade guide or fabric clamp is configured to guide the roll shade and clamp the roll shade fabric to prevent sagging as it is deployed along the head rail. The roll shade may be held to the head rail by one or more holding fixtures selected from the group consisting of clamps, magnets, and hook and loop fasteners. The holding fixtures may ride in the head rail or along the head rail using wheels or sleds. The roll shade fabric may be patterned such that when the shade is deployed or retracted, the relative motion between two sheets of the shade causes the shade to alternatingly assume high and low opacity configurations. The mechanism coupled to the roller tube may include a motor. The motor may be powered by at least one battery.

According to another aspect of the present disclosure, a window covering system is provided. The system includes a head rail, a roller tube attached to one end of a horizontal roll shade, a fixed tube or holder attached to the other end of the horizontal roll shade, and a moveable tube positioned between the roller tube and the fixed tube or holder. The roll shade forms a loop between its ends. The system also includes a mechanism coupled to the roller tube to selectively rotate the roller tube and thereby move the roll shade between a deployed position, wherein the roll shade is open, and a retracted position, wherein the roll shade is closed. The system further includes a plurality of holding fixtures configured from clamps, clips, magnets, hook and loop fasteners or a combination thereof, wherein the holding fixtures ride in the head rail or along the head rail using wheels or sleds. The moveable tube is driven by a device to move it along said head rail and said device is selected from the group consisting of manually, motorized using a belt, cable, string, rack and pinion, chain or pneumatic or hydraulic cylinder.

According to other aspects of the present disclosure, the window covering system may include one or more of the following features. The roller tube may be configured to rotate in both clockwise and counterclockwise directions to move the roll shade between the deployed and retracted positions. The roller tube may be configured to rotate at a variable speed to control the rate at which the roll shade is deployed or retracted. The moveable tube may be configured to translate along the head rail in both directions to facilitate the deployment and retraction of the roll shade. The roll shade fabric may be characterized by alternating strips of high opacity and low opacity to control the amount of light passing through the roll shade. The holding fixtures may be configured to securely hold the roll shade fabric to the head rail without causing damage to the fabric. The mechanism coupled to the roller tube may be configured to automatically stop rotating when the roll shade reaches the fully deployed or fully retracted position.

According to another aspect of the present disclosure, a window covering system is provided. The system includes a head rail, a roller tube attached to one end of a horizontal roll shade, a fixed tube or holder attached to the other end of the horizontal roll shade, and a moveable tube positioned between the roller tube and the fixed tube or holder. The roll shade forms a loop between its ends. The system also includes a mechanism coupled to the roller tube to selectively rotate the roller tube and thereby move the roll shade between a deployed position, wherein the roll shade is open, and a retracted position, wherein the roll shade is closed. The system further includes a pattern on the roll shade, wherein as the roll shade is deployed or retracted, the roll shade moves between low and high opacity configurations. The moveable tube is driven by a device to move it along said head rail and said device is selected from the group consisting of manually, motorized using a belt, cable, string, rack and pinion, chain or pneumatic or hydraulic cylinder.

According to other aspects of the present disclosure, the window covering system may include a roll shade guide or fabric clamp on the head rail, configured to guide the roll shade and clamp the roll shade fabric to prevent sagging as it is deployed along the head rail. The roll shade may be held to the head rail by one or more holding fixtures selected from the group consisting of clamps, magnets, and hook and loop fasteners. These holding fixtures may ride in the head rail or along the head rail using wheels or sleds. The roll shade fabric may be patterned such that when the shade is deployed or retracted, the relative motion between two sheets of the shade causes the shade to alternatingly assume high and low opacity configurations. The mechanism coupled to the roller tube may include a motor, which may be powered by at least one battery.

According to other aspects of the present disclosure, the window covering system may include one or more of the following features. The pattern on the roll shade may comprise alternating strips of high opacity and low opacity. The high opacity strips and the low opacity strips may be arranged in a staggered configuration. The mechanism coupled to the roller tube may be configured to automatically stop rotating when the roll shade reaches the fully deployed or fully retracted position. The moveable tube may be configured to translate along the head rail in both directions to facilitate the deployment and retraction of the roll shade. The holding fixtures may be configured to securely hold the roll shade fabric to the head rail without causing damage to the fabric.

According to other aspects of the present disclosure, the roller tube may be configured to rotate in both clockwise and counterclockwise directions to move the roll shade between the deployed and retracted positions. The roller tube may be configured to rotate at a variable speed to control the rate at which the roll shade is deployed or retracted. The moveable tube may be configured to translate along the head rail in both directions to facilitate the deployment and retraction of the roll shade. The roll shade fabric may be characterized by alternating strips of high opacity and low opacity to control the amount of light passing through the roll shade. The holding fixtures may be configured to securely hold the roll shade fabric to the head rail without causing damage to the fabric. The mechanism coupled to the roller tube may be configured to automatically stop rotating when the roll shade reaches the fully deployed or fully retracted position.

The above and other objects, which will be apparent to those skilled in the art, are achieved in the present invention, which is directed to a horizontal window covering system capable of moving left to right or right to left in a window or door opening, comprising:
a. a head rail mounted above a window or door;
b. a roller tube attached to one end of a horizontal roll shade;
c. a fixed tube or holder attached to the other end of the horizontal roll shade;
d. a moveable tube positioned between the roller tube and the fixed tube or holder, wherein the roll shade fabric forms a loop between its ends;
e. a clamping system capable of holding the horizontal fabric tight and prevent sagging of the roll shade fabric; and
f. a mechanism coupled to the roller tube to selectively rotate the roller tube and thereby move the roll shade between a deployed position, wherein the roll shade is open, and a retracted position, wherein the roll shade is closed.

The foregoing general description of the illustrative embodiments and the following detailed description thereof are merely exemplary aspects of the teachings of this disclosure and are not restrictive.

### BRIEF DESCRIPTION OF FIGURES

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 illustrates an orthogonal front view of a horizontal blind in a closed configuration, according to aspects of the present disclosure.

FIG. 2 illustrates an orthogonal view of a portion of the horizontal blind in a closed configuration, according to an embodiment.

FIG. 3 illustrates an orthogonal view of a portion of a horizontal window covering system, according to aspects of the present disclosure showing the moveable rail.

FIG. 4 illustrates an orthogonal view of the horizontal blind showing moveable rail.

FIG. 5 shows an orthogonal view of a portion of the horizontal blind showing the fabric clamp, according to aspects of the present disclosure.

FIG. 6 shows a section view of the horizontal blind illustrating mechanical components of the roller tube and motor assembly, according to an embodiment.

FIG. 7 shows a sectional view of a portion of a window covering system showing the fabric clamp and roller tube, according to aspects of the present disclosure.

FIG. 8 shows a sectional view of a portion of a window covering system showing the cable, according to an embodiment.

FIG. 9 shows a cross-sectional plan view od section A-A of a window covering system's head rail assembly, according to aspects of the present disclosure.

FIG. 10 shows a cross-sectional plan view od section A-A of a window covering system's head rail assembly, according to aspects of the present disclosure.

FIG. 11 illustrates a section view of a head rail of a horizontal window covering system showing component attachment along the head rail, according to aspects of the present disclosure.

FIG. 12 illustrates a section view of a head rail of a horizontal window covering system using magnetic system to control the sag and bunching of the roll shade.

FIG. 13 illustrates a section view of a head rail of a horizontal window covering system showing the roll shade track.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to a horizontal window covering system designed to provide enhanced control over light transmission and privacy in residential and commercial spaces. This system offers a novel approach to window coverings by utilizing a horizontally deployable shade mechanism, which may provide advantages over traditional vertical blinds or curtains.

The horizontal window covering system may include a head rail mounted above a window or door opening. The head rail may serve as a support structure and guide for the other components of the system. A roll shade may be attached to the head rail and configured to extend horizontally across the width of the opening.

In some cases, the roll shade may form a continuous loop between its attachment points. The system may incorporate a moveable tube positioned along the head rail, which may interface with the roll shade. This moveable tube may enable the roll shade to transition between deployed and retracted positions along the head rail.

The horizontal window covering system may offer flexibility in controlling light transmission and privacy. By allowing horizontal deployment and retraction of the shade material, users may adjust coverage of the window or door opening as desired. This horizontal movement may provide a different aesthetic and functional experience compared to traditional vertical-operating window coverings.

In some implementations, the roll shade may include sections with varying levels of opacity. This feature may allow for further customization of light control and privacy settings. The system may be designed to maintain proper tension and alignment of the shade material during operation, potentially reducing sagging or uneven coverage.

The horizontal window covering system may incorporate motorized components for automated operation. This feature may enhance user convenience and allow for integration with smart home systems or scheduled adjustments of the window covering.

Overall, the horizontal window covering system described herein may offer a novel approach to window treatments, potentially providing improved functionality, aesthetics, and user experience compared to conventional window covering solutions.

The horizontal window covering system 100 may include several main components that work together to provide adjustable shading and privacy control. These components may include a head rail 120, a moveable tube or a roller tube 1235, a fixed tube or holder 520, a fixed side 130, and a roll shade 110.

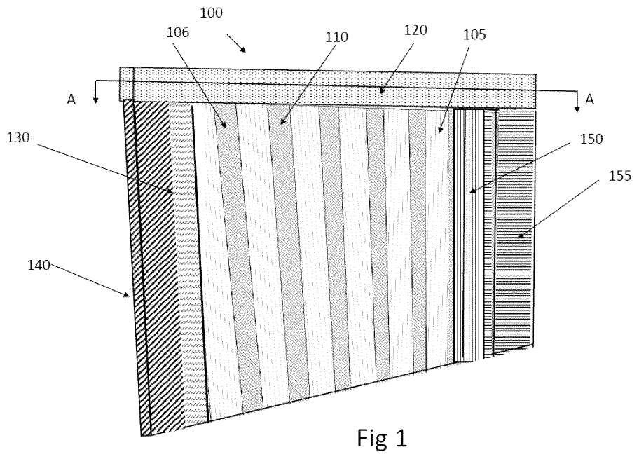

In some cases, the head rail 120 may be mounted above a window or door opening, as shown in FIG. 1. The head rail 120 may serve as a support structure for the other components of the system and may provide a guide for the horizontal movement of the roll shade 110.

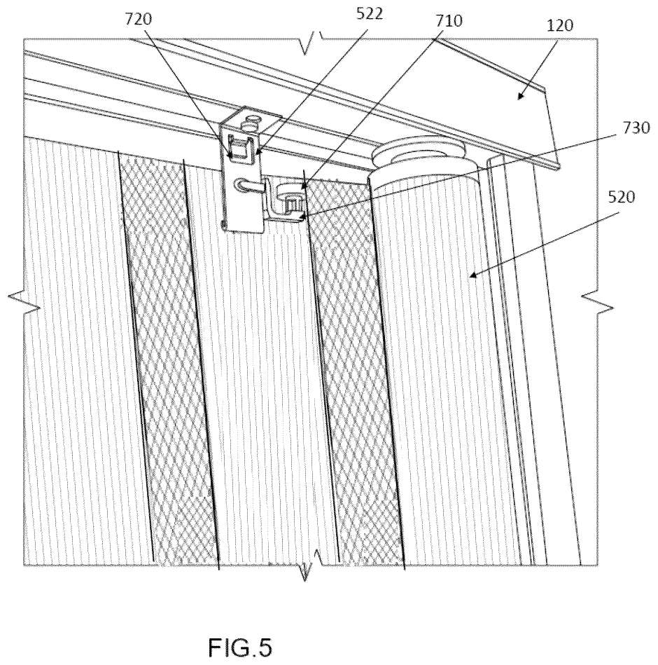

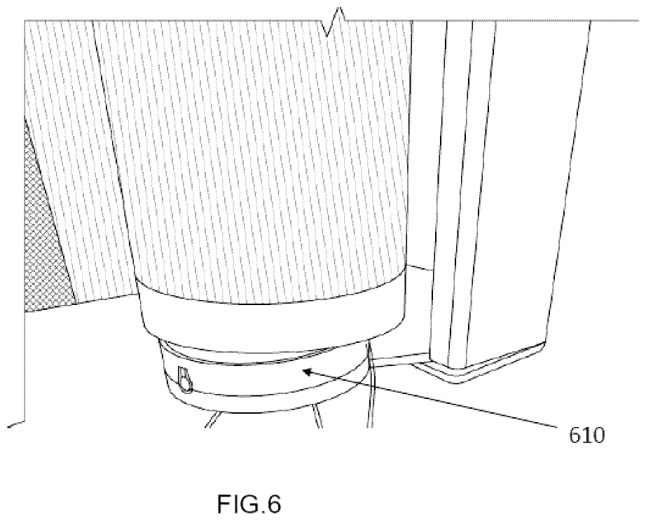

A roller tube, which may be a stationary roller tube 520 in some implementations, may be attached to one end of the roll shade 110. As illustrated in FIG. 5 and FIG. 6, the stationary roller tube 520 may be mounted within the head rail 120. The stationary roller tube 520 may be responsible for storing and releasing the roll shade 110 material as needed.

At the opposite end of the roll shade 110 from the stationary roller tube 520, is a moveable tube or a roller tube 1235. This moveable tube or a roller tube 1235 allows the roll shade 110 to be rolled or unrolled.

Between the stationary roller tube 520 and moveable tube or a roller tube 1235 interfaces with the roll shade 110 and enable the roll shade 110 to transition between deployed and retracted positions along the head rail 120.

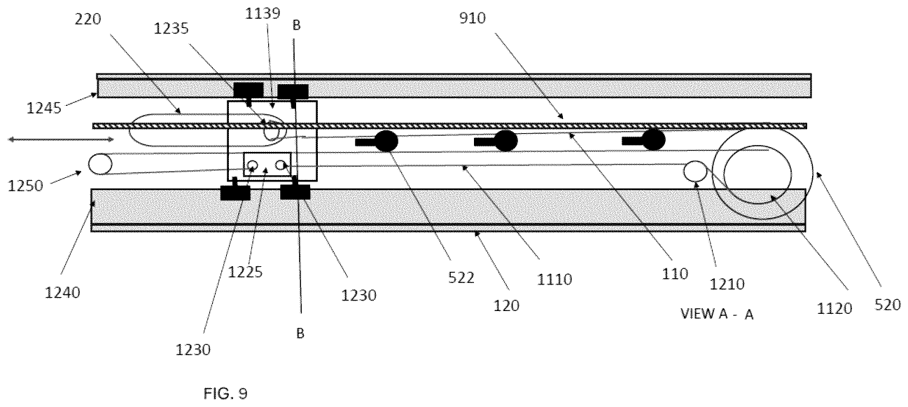

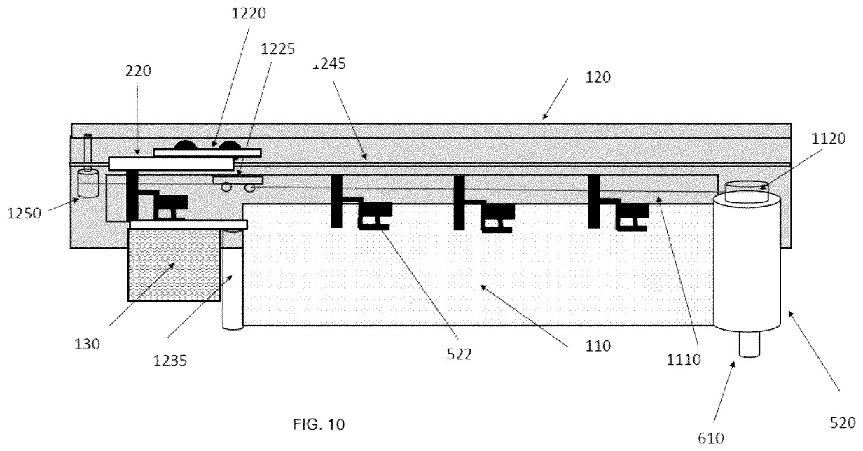

The roll shade 110 itself forms a continuous loop between its attachment points, as depicted in FIG. 9 and FIG. 10. In some cases, the roll shade 110 may include sections with varying levels of opacity. For example, as shown in FIG. 1, the roll shade 110 may comprise alternating translucent panels 105 and opaque panels 106.

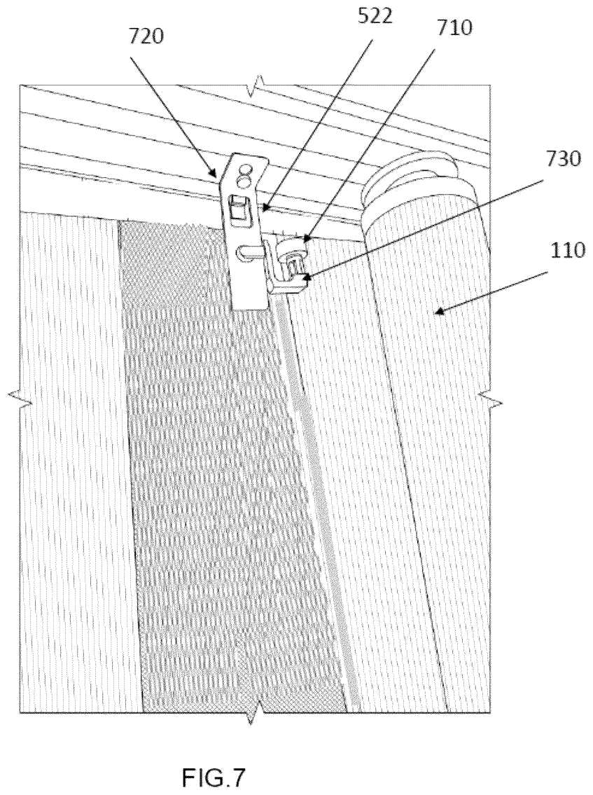

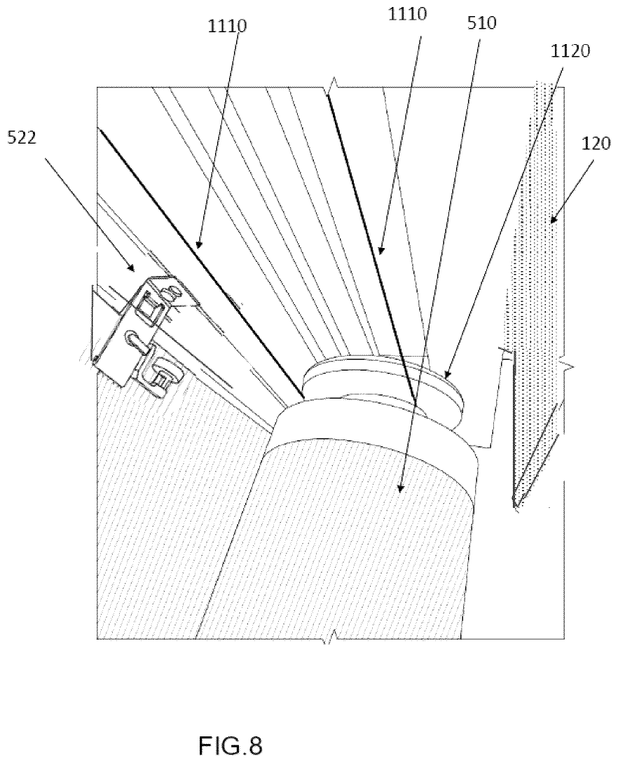

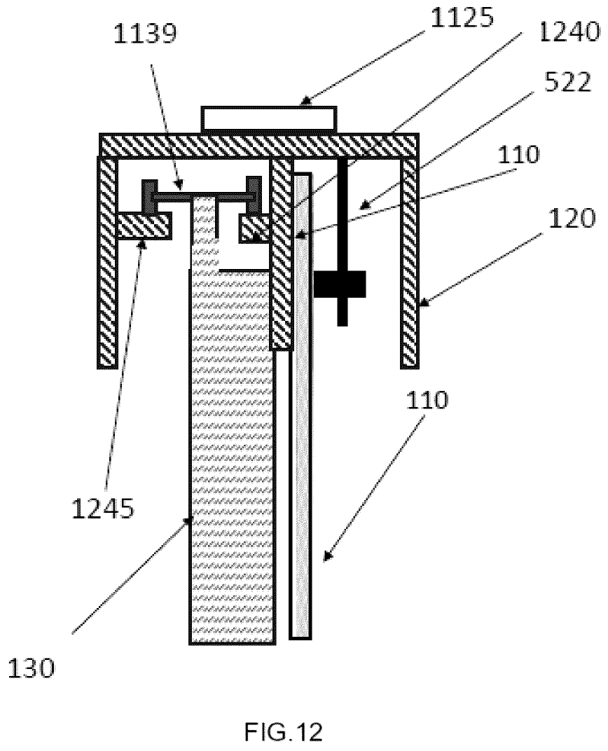

To ensure proper tension and alignment of the roll shade 110 during operation, the system may incorporate various supporting components. As illustrated in FIG. 7, FIG. 8, FIG. 9, and FIG. 10, these may include a fabric clamp 522, a fabric hanger 720, a guide roller 710, and a roller support 730. The fabric clamp 522 may secure and guide the roll shade 110 material, while the guide roller 710, supported by the roller support 730 and connected to the fabric hanger 720. It may facilitate smooth movement of the roll shade 110. Alternatively, the fabric clamp 522 can be replaced with a magnetic system as shown in FIG. 12 where a magnetic strip is woven into the fabric and magnets placed on the head rail 120 so as the magnets hold the tension in the fabric and prevent bunching or drooping of the fabric and therefor keeps the fabric tight as it is deployed or rolled back onto the roller tube 1235 in the stationary rail 150.

In some implementations, the horizontal window covering system may include a mechanism coupled to the stationary roller tube 520 to control its rotation. This mechanism may include a motor 610, as shown in FIG. 6. The motor 610 may enable automated control of the roll shade 110 deployment and retraction. The moveable rail can alternatively be moved by hand where the user provides the force need to deploy or retract roll shade 110.

In some cases, the motor 610 may be powered by at least one battery. This configuration may allow for cordless operation of the horizontal window covering system, enhancing safety and aesthetics.

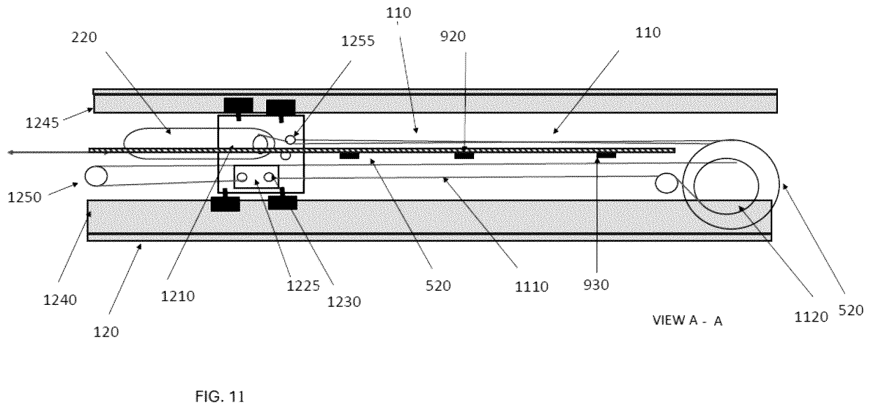

FIG. 11 illustrates additional structural components of the system, including a mounting bracket 1125. The mounting bracket 1125 may be attached to the head rail 120 and may provide additional support for the assembly.

By incorporating these various components, the horizontal window covering system may offer flexible control over light transmission and privacy while maintaining a streamlined and efficient design.

The horizontal window covering system includes a horizontal blind 100, as shown in FIG. 1. The horizontal blind 100 may comprise a roll shade 110 that forms a continuous loop between its attachment points of the roller tube 1235 and stationary tube 520. In some cases, the roll shade 110 may be characterized by alternating sections of different opacity levels.

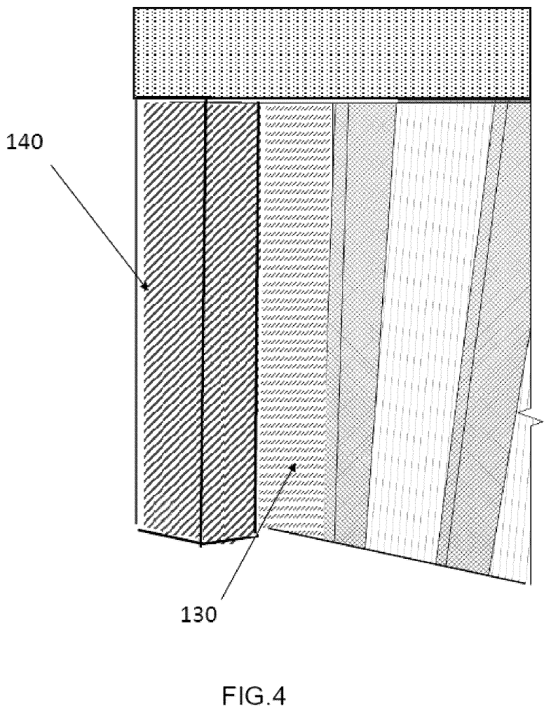

As illustrated in FIG. 4, the roll shade 110 may include a translucent panel 105 and an opaque panel 106. These panels may be arranged in alternating strips along the length of the roll shade 110. The translucent panel 105 may allow a certain amount of light to pass through, while the opaque panel 106 may block most or all light transmission. This configuration may enable variable light control as the roll shade 110 is deployed or retracted.

The roll shade 110 may operate in conjunction with the roller tube 1235, as depicted in FIG. 10 and FIG. 11. The roller tube 1235 may translate along the head rail 120, facilitating the deployment and retraction of the roll shade 110. As the roller tube 1235 moves, the roll shade 110 may unwind from or wind onto the stationary roller tube 520, changing the relative positions of the translucent panels 105 and opaque panels 106.

In some cases, the stationary roller tube 520 may rotate at a variable speed to control the rate at which the roll shade 110 is deployed or retracted. This variable speed rotation may be achieved through the use of the motor 610, as shown in FIG. 6. The motor 610 may be programmed or controlled to adjust its rotational speed, allowing for precise control over the movement of the roll shade 110.

The fabric clamp 522, guide roller 710, fabric hanger 720, and roller support 730, as illustrated in FIG. 7, FIG. 8, FIG. 9, and FIG. 10, may work together to maintain proper tension and alignment of the roll shade 110 during operation. These components may help ensure smooth movement of the roll shade 110 as it transitions between deployed and retracted positions, preserving the intended pattern of alternating translucent panel 105 and opaque panel 106.

The mounting bracket 1125, shown in FIG. 11, may provide additional structural support for the head rail 120 and other components of the horizontal blind 100. This support may contribute to the stable operation of the roll shade 110 as it moves horizontally along the head rail 120.

By combining the patterned structure of the roll shade 110 with the controlled movement provided by the roller tube 1235 and stationary roller tube 520, the horizontal blind 100 may offer precise adjustment of light transmission and privacy levels. The alternating translucent panel 105 and opaque panel 106 may create a dynamic shading effect as the roll shade 110 is deployed or retracted, providing users with flexible control over their environment.

The head rail assembly of the horizontal blind may include several components that work together to support and guide the roll shade during operation. As illustrated in FIG. 5, the head rail may house a stationary tube 520 and a fabric clamp 522. The stationary tube 520 may be mounted within the head rail 120 and serve as an anchor point for one end of the roll shade 110. The fabric clamp 522 may be attached to the head rail 120 and may function to secure and guide the roll shade 110 material as it moves along the head rail. The fabric clamp 522 keep the tension on the roll shade 110 and ensures that the roll shade 110 does not sag.

In some cases, the roll shade may be held to the head rail by holding fixtures. These holding fixtures may include clamps, magnets, or hook and loop fasteners. The holding fixtures may ride in the head rail or along the head rail using wheels or sleds, allowing for smooth movement of the roll shade during deployment and retraction.

FIG. 6 shows a section view of the head rail assembly, highlighting the integration of a motor with the stationary tube 520. The motor may be coupled to the stationary tube 520 to provide automated control over the rotation of the stationary tube 520, facilitating the deployment and retraction of the roll shade 110.

The head rail may also incorporate a roll shade guide or fabric clamp that clamps the roll shade fabric to prevent sagging. This feature may help maintain proper tension and alignment of the roll shade as it moves horizontally along the head rail.

FIG. 7 illustrates additional components of the head rail assembly that contribute to the support and guidance of the roll shade. The fabric clamp 522 may work in conjunction with a guide roller 710, a fabric hanger 720, and a roller support 730. The guide roller 710 may facilitate smooth movement of the roll shade 110, while the fabric hanger 720 may provide structural support for the guide roller 710. The roller support 730 may connect the guide roller 710 to the fabric hanger 522, enabling controlled rotation of the roller.

In some implementations, the fabric clamp 522 may be designed to securely hold the roll shade 110 to the head rail without causing damage to the material. This may allow for reliable operation of the horizontal blind while preserving the integrity of the roll shade fabric.

The combination of these components within the head rail 120 assembly may provide a robust support and guidance system for the roll shade. This system may enable smooth horizontal deployment and retraction of the roll shade while maintaining proper tension and alignment throughout its operation.

The horizontal blind may incorporate various mechanisms for managing fabric tension and alignment to ensure smooth operation of the roll shade. These mechanisms may include fabric clamps, guide rollers, and support structures that work together to prevent sagging and maintain proper positioning of the roll shade during deployment and retraction.

FIG. 8 illustrates key components of the fabric deployment and retrieval system. The fabric clamp may be designed to securely hold the roll shade to the head rail without causing damage to the fabric. The cable 1110 is attached to the cable bracket 1225 and runs around the cable spool 1250. In some cases, the fabric clamp may incorporate a guide roller to facilitate smooth movement of the roll shade as it transitions between deployed and retracted positions.

The guide roller 710 may be supported by a roller support, which may connect the guide roller to a fabric hanger. This arrangement, as shown in FIG. 7, may allow for controlled rotation of the guide roller while providing structural stability to the assembly. The fabric hanger may be attached to the head rail, ensuring that the guide roller maintains proper alignment with the roll shade during operation.

FIG. 10 provides a sectional elevation view along cross section A-A.

FIG. 11 provides a sectional elevation view along cross section A-A. provides a detailed view of how the components that manage fabric tension using magnets to prevent sagging or bunching. The roll shade, which may include both the translucent panel and the opaque panel, may pass around the guide roller in a controlled manner.

In some cases, the fabric clamp 522 may be adjustable, allowing for fine-tuning of the tension applied to the roll shade. This adjustability may help accommodate different fabric weights or compensate for any stretching that may occur over time.

The stationary roller tube 520 may work in conjunction with the guide roller 522 to maintain proper fabric positioning and movement through the system. As the roll shade is deployed or retracted, the tension management system may ensure that the fabric remains taut and aligned, preserving the intended pattern of alternating translucent panel and opaque panel sections.

The fabric management and tension control mechanisms may be designed to operate smoothly and quietly, enhancing the user experience when adjusting the horizontal blind. By maintaining proper tension and alignment, these components may contribute to the longevity and reliable operation of the roll shade system.

The horizontal window covering system may integrate various components to provide adjustable shading and privacy control. As shown in FIG. 1, the system may include a horizontal blind 100 comprising a head rail 120, a roll shade 110, and a moveable tube 130. These components may work together to enable horizontal deployment and retraction of the roll shade 110.

In some cases, the roll shade 110 may form a continuous loop between its attachment points, as illustrated in FIG. 10 and FIG. 11. The roll shade 110 may include alternating sections of translucent panel 105 and opaque panel 106, as depicted in FIG. 1. This configuration may allow for variable light control as the roll shade 110 is deployed or retracted.

The head rail 120 may house several key components of the system. As shown in FIG. 10 and FIG. 11 and FIG. 12. FIG. 12 is a cross-sectional view of cross section B-B shown in FIG. 9. The horizontal blind 100 showing the head rail 120 which contains a stationary tube 520 and a fabric clamp 522. The stationary tube 520 may be responsible for storing and releasing the roll shade 10 material during operation.

FIG. 6 illustrates the integration of a motor 610 with the stationary roller tube 520. The motor 610 may provide automated control over the rotation of the stationary roller tube 520, facilitating the deployment and retraction of the roll shade 110.

The system may incorporate various mechanisms to manage fabric tension and alignment. FIG. 5, FIG. 7, FIG. 8, FIG. 9, and FIG. 11 depict components such as the fabric clamp 522, guide roller 710, fabric hanger 720, and roller support 730. These elements may work together to maintain proper tension and positioning of the roll shade 110 during operation.

In some cases, the moveable tube 130 may be driven by a device to move along the head rail 120. The device may include a belt, cable, string, rack and pinion, chain, pneumatic cylinder, or hydraulic cylinder. This mechanism may enable controlled horizontal movement of the roll shade 110.

The deployment process may begin with the motor 610 rotating the stationary roller tube 520 to release the roll shade 110. As the roll shade 110 unwinds, the moveable tube 130 may translate along the head rail 120, guided by the fabric clamp 522 and guide roller 710. The alternating translucent panel 105 and opaque panel 106 sections may create a dynamic shading effect as the roll shade 110 extends.

The ability to keep the tension in the fabric as it traverses horizontally important to the horizontal shade. The fabric clamp 522 guide roller 710 keeps the fabric tight to the backing bar 910. Alternatively the fabric clamp 522 can be replaced with a magnetic system where magnetic 930 is woven into the fabric and Ferrous 920 placed on the head rail 120 so as the magnets hold the tension in the fabric and prevent bunching or drooping of the fabric and therefor keeps the fabric tight as it is deployed or rolled back onto the roller tube 1235 in the stationary rail 150. However, the magnets and ferrous material can be swapped so that there is a ferrous strip 920 in the fabric and the magnets 930 are placed on the head rail 120.

During retraction, the process may reverse. The motor 610 may rotate the stationary roller tube 520 in the opposite direction, winding the roll shade 110 back onto the tube. The moveable tube 130 may return towards its starting position, guided by the tension management system. The moveable rail can alternatively be moved by hand where the user provides the force need to deploy or retract roll shade 110.

In some cases, the mechanism coupled to the stationary roller tube 520 may be configured to automatically stop rotating when the roll shade 110 reaches the fully deployed or fully retracted position. This feature may prevent over-extension or over-retraction of the roll shade 110.

The mounting bracket 1125, as shown in FIG. 11, may provide additional structural support for the head rail 120 and other components of the horizontal blind 100. This support may contribute to the stable operation of the roll shade 110 as it moves horizontally along the head rail 120.

By integrating these components and mechanisms, the horizontal window covering system may offer precise control over light transmission and privacy. Users may adjust the position of the roll shade 110 to achieve desired levels of shading and visibility, leveraging the alternating opacity pattern of the roll shade 110 material.

The instant innovation can further be described as a window covering system, comprising:
a. a head rail;
b. a roller tube attached to one end of a horizontal roll shade and the roll shade captured between at least one fabric clamp and a backing bar;
c. a moveable tube positioned between the roller tube and the fixed tube or holder, wherein the roll shade forms a loop between its ends;
d. a motor mechanism coupled to the roller tube to selectively rotate the roller tube and thereby move the roll shade between a deployed position and a retracted position; and
e. a device to move the moveable tube along the head rail.

The window covering system of the instant innovation, wherein the device to move the moveable tube along the head rail is selected from the group consisting of a belt, a cable, a string, a rack and pinion, a chain, a pneumatic cylinder, and a hydraulic cylinder.

The window covering system of the instant innovation, further comprising a fabric clamp on the head rail, wherein the fabric clamp is configured to guide the roll shade and clamp the roll shade fabric to prevent sagging as it is deployed along the head rail.

The window covering system of the instant innovation, wherein the roll shade is held to the head rail by one or more holding fixtures selected from the group consisting of clamps, magnets, and hook and loop fasteners.

The window covering system of the instant innovation, wherein the holding fixtures ride in the head rail or along the head rail using wheels or sleds.

The window covering system of the instant innovation, wherein the roll shade fabric is patterned such that when the shade is deployed or retracted, the relative motion between two sheets of the shade causes the shade to alternatingly assume high and low opacity configurations.

The window covering system of the instant innovation, wherein the mechanism coupled to the roller tube includes a motor powered by at least one battery.
a. A method of operating a window covering system, comprising:
b. mounting a head rail above a window or door;
c. attaching a roller tube to one end of a horizontal roll shade;
d. attaching a fixed tube or holder to the other end of the horizontal roll shade;
e. positioning a moveable tube between the roller tube and the fixed tube or holder, wherein the roll shade forms a loop between its ends;
f. coupling a mechanism to the roller tube; and
g. selectively rotating the roller tube to move the roll shade between a deployed position and a retracted position.

The method of the instant innovation, further comprising moving the moveable tube along the head rail using a device selected from the group consisting of a belt, a cable, a string, a rack and pinion, a chain, a pneumatic cylinder, and a hydraulic cylinder.

The method of the instant innovation, further comprising guiding the roll shade and clamping the roll shade fabric using a fabric clamp on the head rail to prevent sagging as the roll shade is deployed along the head rail.

The method of the instant innovation, further comprising holding the roll shade to the head rail using one or more holding fixtures selected from the group consisting of clamps, magnets, and hook and loop fasteners.

The method of the instant innovation, wherein the holding fixtures ride in the head rail or along the head rail using wheels or sleds.

The method of the instant innovation, wherein the roll shade fabric is patterned such that when the shade is deployed or retracted, the relative motion between two sheets of the shade causes the shade to alternatingly assume high and low opacity configurations.

The method of the instant innovation, wherein the mechanism coupled to the roller tube includes a motor powered by at least one battery, and further comprising automatically stopping rotation of the roller tube when the roll shade reaches a fully deployed or fully retracted position.

A window covering system, comprising:
a. a head rail;
b. a horizontal roll shade forming a loop;
c. a roller tube attached to one end of the horizontal roll shade;
d. a fixed tube or holder attached to the other end of the horizontal roll shade;
e. a moveable tube positioned between the roller tube and the fixed tube or holder; and
f. a pattern on the roll shade, wherein as the roll shade is deployed or retracted, the roll shade moves between low and high opacity configurations.

The window covering system of the instant innovation, wherein the pattern on the roll shade comprises alternating strips of high opacity and low opacity.

The window covering system of the instant innovation, wherein the high opacity strips and the low opacity strips are arranged in a staggered configuration.

The window covering system of the instant innovation, further comprising a mechanism coupled to the roller tube to selectively rotate the roller tube and thereby move the roll shade between a deployed position and a retracted position.

The window covering system of the instant innovation, wherein the mechanism includes a motor powered by at least one battery.

The window covering system of the instant innovation, wherein the mechanism is configured to automatically stop rotating the roller tube when the roll shade reaches a fully deployed or fully retracted position.

Referring now to the drawings FIG. 1-13, and more particularly to FIG. 1, there is shown an orthogonal front view of a horizontal blind 100 in a closed configuration, according to aspects of the present disclosure. The horizontal blind 100 comprises of a fabric panel or roll shade 110 having alternating opaque panels 106 and translucent panels 105. The roll shade 110 is supported in a head rail 120. The horizontal blind 100 has stationary rail 150 and moveable rail 140. The roll shade 110 moves from the stationary rail 150 following the moveable rail 140 and as the moveable rail 140 moves along the head rail 120 the roll shade 110 having alternating opaque panels 106 and translucent panels 105 is deployed so that the alternating opaque panels 106 and translucent panels 105 are displayed so that the light transmitted through the roll shade 105 is controlled as the opaque panels 106 and translucent panels 105 align and become unaligned. The head rail 120 has a roll shade 110 tensioning system that supports the horizontal deployed roll shade 110 so that the roll shade 110 does not sag or bunch as the roll shade is deployed or retracted. Traditionally the roll shade 110 can only be used in a vertical orientation which depends on being captured between a payout roll and a turning roll.

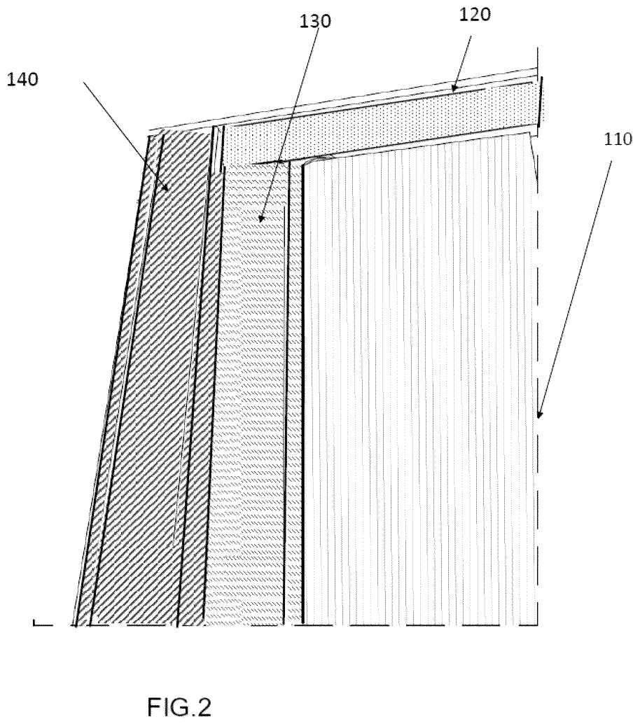

FIG. 2 shows a view of a portion of the horizontal blind in a closed configuration, according to an embodiment. The view shows the moveable rail 130 and the moveable rail side door frame 140, head rail 120 and role shade 110.

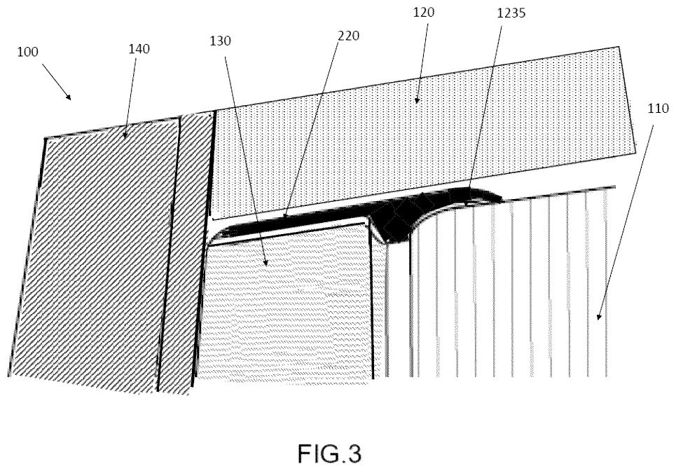

FIG. 3 shows a view of a portion of a horizontal window covering system, according to aspects of the present disclosure showing the moveable rail 130 and the moveable rail side door frame 140, roller tube 1235, moveable rail top support 220, head rail 120 and role shade 110.

FIG. 4 shows a view of the horizontal blind showing moveable rail 130 in position against the moveable rail side door frame 140.

FIG. 5 shows a view of a portion of the horizontal blind showing the fabric clamp 522, according to aspects of the present disclosure. The fabric clamp 522 is comprised of a fabric hanger 720, a guide roller 710, and a roller support 730. The fabric clamp 522 may secure and guide the roll shade 110 material, while the guide roller 710, supported by the roller support 730 and connected to the fabric hanger 720. It facilitates smooth movement and holds the roll shade material tight and prevents sagging and bunching of the roll shade 110 as it is deployed from or retrieved from the stationary roller tube 520 which holds the roll shade 110.

FIG. 6 shows a section view of the horizontal blind illustrating mechanical components of the roller tube and motor 610, according to an embodiment.

FIG. 7 shows a sectional view of a portion of a horizontal blind showing the fabric clamp 522 and roller tube 110, fabric hanger 720, a guide roller 710, and a roller support 730 according to aspects of the present disclosure. The guide roller 710 captures the roll shade 110 allowing the front and the back piece of fabric to be held tight but side in relation to each piece when the roll shade 110 as it is deployed from or retrieved from the stationary roller tube 520 which holds the roll shade 110.

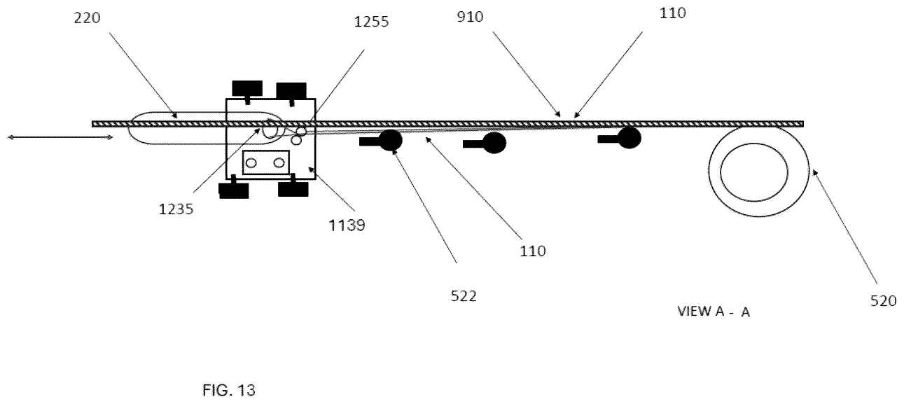

FIG. 8 shows a sectional view of a portion of a window covering system showing the cable 1110 which is attached to the trolley 1139 shown in FIG. 11 that supports the moveable rail 130. The trolley also supports the roller tube 1235 that the roll shade 110 fabric, according to an embodiment. fabric clamp 522 and roller tube 1235, fabric hanger 720, a guide roller 710, and a roller support 730 according to aspects of the present disclosure. The guide roller 710 captures the roll shade 110 allowing the front and the back piece of fabric to be held tight but side in relation to each piece when the roll shade 110 as it is deployed from or retrieved from the stationary roller tube 520 which holds the roll shade 110. The fabric of the roll shade 110 is deployed from stationary tube 520 and goes around roller tube 1235 shown in FIG. 9. The roll shade 110 fabric, fabric motion is shown in FIG. 13. The roll shade 110 is strung between stationary roll 520 and roller tube 1235. The roller tube 1235 separates and allows the fabric to rotate around the roller tube 1235 so that the opaque panels 106 and translucent panels 105 align and become unaligned.

FIG. 9 shows a cross-sectional plan view of section A-A of a window covering system's head rail assembly, according to aspects of the present disclosure. Head rail 120 has tracks 1240 and 1245 which supports trolley 1139. The trolley 1139 supports the moveable rail 130 (shown in FIG. 10) from moveable rail top support 220, roller tube 1235. The trolley 1139 also supports the cable bracket 1225, cable end tie off 1230. The fabric clamps 522 capture the roll shade 110 between the fabric clamps 522 and backing bar 910. The cable 1110 runs from stationary cable spool 1120 around 1dler 1210 to the cable bracket 1225. The cable 1110 runs around cable end spool 1250. The roll shade 110 runs from stationary tube 520 to roller tube 1235.

FIG. 10 shows a cross-sectional plan view od section A-A of a window covering system's head rail assembly, according to aspects of the present disclosure. Using both FIG. 10 and FIG. 9. The Head rail 120 has tracks 1240 and 1245 which supports trolley 1139. The trolley 1139 supports the moveable rail 130 (shown in FIG. 10) from moveable rail top support 220, roller tube 1235. The trolley 1139 also supports the cable bracket 1225, cable end tie off 1230. The fabric clamps 522 capture the roll shade 110 between the fabric clamps 522 and backing bar 910. The cable 1110 runs from stationary cable spool 1120 around 1dler 1210 to the cable bracket 1225. The cable 1110 runs around cable end spool 1250. The roll shade 110 runs from stationary tube 520 to roller tube 1235.

FIG. 11 illustrates a section view of a head rail of a horizontal window covering system showing component attachment along the head rail, according to aspects of the present disclosure. Head rail 120 has tracks 1240 and 1245 that support the trolley 1139 which supports moveable rail top support 220 and moveable rail 130. The roll shade 110 is captured between backing bar 910.

FIG. 12 illustrates a section view of a head rail of a horizontal window covering system using magnetic system to control the sag and bunching of the roll shade 110. Using both FIG. 12, FIG. 10 and FIG. 9. The Head rail 120 has tracks 1240 and 1245 which supports trolley 1139. The trolley 1139 supports the moveable rail 130 (shown in FIG. 10) from moveable rail top support 220, roller tube 1235. The trolley 1139 also supports the cable bracket 1225, cable end tie off 1230. The magnets 930 capture the roll shade 110 between the magnets 930 and ferrous bar 920. The cable 1110 runs from stationary cable spool 1120 around 1dler 1210 to the cable bracket 1225. The cable 1110 runs around cable end spool 1250. The roll shade 110 runs from stationary tube 520 to roller tube 1235.

FIG. 13 illustrates a section view of a head rail of a horizontal window covering system showing the roll shade 110 track. Using both FIG. 12, FIG. 10 and FIG. 9. The Head rail 120 has tracks 1240 and 1245 which supports trolley 1139. The trolley 1139 supports the moveable rail 130 (shown in FIG. 10) from moveable rail top support 220, roller tube 1235. The trolley 1139 also supports the cable bracket 1225, cable end tie off 1230. The fabric clamps 522 capture the roll shade 110 between the fabric clamps 522 and backing bar 910. The cable 1110 runs from stationary cable spool 1120 around 1dler 1210 to the cable bracket 1225. The cable 1110 runs around cable end spool 1250. The roll shade 110 runs from stationary tube 520 to roller tube 1235.

A number of implementations have been described. Nevertheless, it will be understood that various modifications may be made without departing from the spirit and scope of the disclosure. Accordingly, other implementations are within the scope of the following claims.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments; it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A window covering system, comprising:
a head rail;
a roller tube attached to one end of a horizontal roll shade and the roll shade captured between at least one fabric clamp and a backing bar;
a moveable tube positioned between the roller tube and the fixed tube or holder, wherein the roll shade forms a loop between its ends;
a motor mechanism coupled to the roller tube to selectively rotate the roller tube and thereby move the roll shade between a deployed position and a retracted position; and
a device to move the moveable tube along the head rail.

2. The window covering system of claim 1, wherein the device to move the moveable tube along the head rail is selected from the group consisting of a belt, a cable, a string, a rack and pinion, a chain, a pneumatic cylinder, and a hydraulic cylinder.

3. The window covering system of claim 1, further comprising a fabric clamp on the head rail, wherein the fabric clamp is configured to guide the roll shade and clamp the roll shade fabric to prevent sagging as it is deployed along the head rail.

4. The window covering system of claim 1, wherein the roll shade is held to the head rail by one or more holding fixtures selected from the group consisting of clamps, magnets, and hook and loop fasteners.

5. The window covering system of claim 4, wherein the holding fixtures ride in the head rail or along the head rail using wheels or sleds.

6. The window covering system of claim 1, wherein the roll shade fabric is patterned such that when the shade is deployed or retracted, the relative motion between two sheets of the shade causes the shade to alternatingly assume high and low opacity configurations.

7. The window covering system of claim 1, wherein the mechanism coupled to the roller tube includes a motor powered by at least one battery.

8. A method of operating a window covering system, comprising:
mounting a head rail above a window or door;
attaching a roller tube to one end of a horizontal roll shade;
attaching a fixed tube or holder to the other end of the horizontal roll shade;
positioning a moveable tube between the roller tube and the fixed tube or holder, wherein the roll shade forms a loop between its ends;
coupling a mechanism to the roller tube; and
selectively rotating the roller tube to move the roll shade between a deployed position and a retracted position.

9. The method of claim 8, further comprising moving the moveable tube along the head rail using a device selected from the group consisting of a belt, a cable, a string, a rack and pinion, a chain, a pneumatic cylinder, and a hydraulic cylinder.

10. The method of claim 8, further comprising guiding the roll shade and clamping the roll shade fabric using a fabric clamp on the head rail to prevent sagging as the roll shade is deployed along the head rail.

11. The method of claim 8, further comprising holding the roll shade to the head rail using one or more holding fixtures selected from the group consisting of clamps, magnets, and hook and loop fasteners.

12. The method of claim 11, wherein the holding fixtures ride in the head rail or along the head rail using wheels or sleds.

13. The method of claim 8, wherein the roll shade fabric is patterned such that when the shade is deployed or retracted, the relative motion between two sheets of the shade causes the shade to alternatingly assume high and low opacity configurations.

14. The method of claim 8, wherein the mechanism coupled to the roller tube includes a motor powered by at least one battery, and further comprising automatically stopping rotation of the roller tube when the roll shade reaches a fully deployed or fully retracted position.

15. A window covering system, comprising:
a head rail;
a horizontal roll shade forming a loop;
a roller tube attached to one end of the horizontal roll shade;
a fixed tube or holder attached to the other end of the horizontal roll shade;
a moveable tube positioned between the roller tube and the fixed tube or holder; and
a pattern on the roll shade, wherein as the roll shade is deployed or retracted, the roll shade moves between low and high opacity configurations.

16. The window covering system of claim 15, wherein the pattern on the roll shade comprises alternating strips of high opacity and low opacity.

17. The window covering system of claim 16, wherein the high opacity strips and the low opacity strips are arranged in a staggered configuration.

18. The window covering system of claim 15, further comprising a mechanism coupled to the roller tube to selectively rotate the roller tube and thereby move the roll shade between a deployed position and a retracted position.

19. The window covering system of claim 18, wherein the mechanism includes a motor powered by at least one battery.

20. The window covering system of claim 19, wherein the mechanism is configured to automatically stop rotating the roller tube when the roll shade reaches a fully deployed or fully retracted position.
